(19) United States
(12) Patent Application Publication
(10) Pub. No.: US 2026/0081705 A1
(43) Pub. Date: Mar. 19, 2026

(54) TEST AND/OR MEASUREMENT INSTRUMENT AND METHOD FOR DETERMINING A POWER OF AN INPUT SIGNAL

(71) Applicant: Rohde & Schwarz GmbH & Co. KG, Muenchen (DE)

(72) Inventors: Matthias RUENGELER, Muenchen (DE); Gregor FELDHAUS, Muenchen (DE); Christian PRICK, Muenchen (DE)

(21) Appl. No.: 18/886,671

(22) Filed: Sep. 16, 2024

(51) Int. Cl. H04B 17/318; H04B 1/10

(52) U.S. Cl. CPC H04B 17/318; H04B 1/1018

(57) ABSTRACT

The present disclosure generally relates to a test and/or measurement instrument and a method for determining a power of an input signal. The test and/or measurement instrument includes at least one input for receiving an input signal, at least one acquisition circuit, and at least one analysis circuit. The at least one acquisition circuit includes at least one analog-to-digital converter configured to provide a digital signal comprising multiple samples. The at least one analysis circuit is configured to separate different samples of the digital signal into at least two partitions, to transform signal portions of the at least two partitions into frequency domain, to determine for the different transformed signal portions an average part and a variance part, and to determine a constant part of the digital signal by compensating the average part with the variance part.

### FIELD OF THE DISCLOSURE

The present disclosure generally relates to a test and/or measurement instrument and a method for determining a power of an input signal.

### BACKGROUND

For many applications, a signal power, such as a power of a radio frequency (RF) signal, may be determined for further signal processing or evaluation. In this regard, current approaches make use of root mean square (RMS) detectors for determining the power of the signal in question.

However, an RMS detector has a limited resolution bandwidth meaning that the RMS detector evaluates a frequency interval at once, wherein the length of the frequency interval depends on the resolution bandwidth. Within this frequency interval, the RMS cannot distinguish between the actual signal and noise contained within the signal or noise which is adjacent to the signal with regard to frequency, but within the frequency interval, e.g. noise at an adjacent frequency. Since at least the RMS detector itself inherently adds some noise power to the signal, the power of the signal up to now cannot be determined correctly with known RMS detectors.

Hence, there is a need for a measurement instrument and a corresponding method by which the influence of noise signal portions on the determination of signal power of the signal can be reduced or even omitted.

### SUMMARY

A summary of certain embodiments disclosed herein is set forth below. It should be understood that these aspects are presented merely to provide a brief summary of these embodiments and that these aspects are not intended to limit the scope of this disclosure. This disclosure may encompass a variety of aspects that may not be set forth below. Some aspects as explained in view of methods, others in view of devices. However, the respective aspects are to be correspondingly transferred from methods to devices and vice versa.

Embodiments of the present disclosure relate to a test and/or measurement instrument for determining a power of an input signal. In an embodiment, the test and/or measurement instrument comprises at least one input for receiving an input signal and at least one acquisition circuit being connected to the input. The at least one acquisition circuit comprises at least one analog-to-digital converter (ADC) configured to digitize the input signal received from the input, thereby providing a digital signal comprising multiple samples. The digital signal comprises a wanted signal component and a noise signal component.

According to this embodiment, the test and/or measurement instrument also comprises at least one analysis circuit being connected with the at least one acquisition circuit such that the analysis circuit receives the digital signal from the acquisition circuit. In an embodiment, the analysis circuit is configured to: separate different samples of the digital signal into at least two partitions; transform signal portions of the two partitions into a frequency domain, thereby obtaining transformed signal portions; determine for the different transformed signal portions an average part and a variance part; and determine a constant part of the digital signal having a constant signal power by compensating the average part with the variance part.

Examples of the test and/or measurement instrument disclosed herein are based on the finding that a separation of the digital signal into individual partitions can be used to apply an analysis technique where several samples of the digital signal are evaluated with respect to each other. For this purpose, the input signal is digitized so as to obtain the multiple samples in time domain. The multiple samples are separated into the different partitions, also called segments. Afterwards, each partition/segment is transformed into frequency domain, namely the samples encompassed therein, such that the transformed signal portions are obtained which relate to the partitions/segments. The transformed signal portions obtained can be analyzed further so as to determine an average part and a variance part.

In an embodiment, the average part may relate to a mean value, e.g. the mean power, whereas the variance part relates to the variance, namely the variance of the power caused by other signals than the wanted signal component, e.g. the noise signal component(s). Accordingly, the variance part is associated with an additional power contribution that is also included within the average part. Consequently, the variance part can be compensated from the average part such that a constant part of the digital signal is determined which has a constant power. The constant part relates to the wanted signal component encompassed in the digital signal, namely the digitized input signal.

In other words, as the separate partitions are put in relation to each other, namely the frequency resolved transformed signal portions, the variance part can be identified. This variance part originates from noise signal components included within the underlying evaluated digital signal, irrespective of whether the noise was included already within the input signal or is caused by the signal processing performed by the test and/or measurement instrument itself, such as by the acquisition circuit, e.g. components of the acquisition circuit.

The contribution of signal portions “hidden” within the average part can be compensated therefrom by taking the average part and the variance part into account so as to determine the constant part representing a signal having constant power, namely the wanted signal component. The wanted signal component in turn represents the true signal portion of the input signal which is of interest and for which the power is to be determined. In this regard, the assumption is applied that the wanted signal component is constant during the evaluation procedure.

Put differently, the test and/or measurement instrument makes use of an analysis technique, where instantaneous power at several time instances is measured by the analysis circuit in view of the samples of the digital signal provided by the ADC. In this course, the instrument evaluates the variance of these measurements in terms of the frequency resolved signal portions, namely the transformed signal portions.

Hence, the true signal power of the wanted signal component underlying the digital signal evaluated can be reliably determined. Subsequently, the signal power of the wanted signal component, and therewith the signal power of the input signal can be made use of for further signal evaluation or signal processing. Since known RMS detectors are not configured to identify noise contributions when determining the signal power, the precision and accuracy of the determination procedure employed by the test and/or measurement instrument is improved as compared to those known RMS detectors.

Particularly, known RMS detectors inherently add the noise power to the signal power and thus the power of the signal is not measured correctly since the known RMS detectors are not configured to separate the samples of the digital signal into different partitions for identifying the average part and the variance part based on which the constant part of the digital signal with constant power can be determined. Hence, the test and/or measurement instrument provides a completely new evaluation technique by making use of several partitions, as the transformed signal portions associated with the partitions are analyzed commonly, in particular for determining the variance part.

Each signal portion or partition may comprise several samples. Consequently, the transformed signal portions each may comprise several frequency components, e.g. frequency bins like FFT bins.

When determining the average part and the variance part, a specific frequency component, e.g. a specific frequency bin, of the different transformed signal portions may be taken into account.

For instance, the respective second frequency component of the different transformed signal portions may be taken into account. In other words, the average part and the variance part are determined based on the second frequency component of the first transformed signal portion, the second frequency component of the second transformed signal portion, the second frequency component of the third transformed signal portion, the second frequency component of the fourth transformed signal portion, and so on.

This concept may also apply for the respective first frequency component, the respective third frequency component, the respective fourth frequency component, the respective fifth frequency component of the different transformed signal portions, and so on.

In an embodiment, the average part and the variance part may be determined for each respective frequency component of the different transformed signal portions.

According to an aspect, embodiments of the present disclosure relate to a method for determining a power of an input signal. In an embodiment, an input signal is received by an input of a test and/or measurement instrument. The input signal is digitized by the ADC of the acquisition circuit of the test and/or measurement instrument, thereby generating a digital signal comprising multiple samples. The digital signal comprises a wanted signal component and a noise signal component. The digital signal is forwarded to the analysis circuit of the test and/or measurement instrument. Different samples of the digital signal are separated into at least two partitions by the analysis circuit. Signal portions of the at least two partitions are transformed into frequency domain by the analysis circuit, thereby obtaining transformed signal portions. For the different transformed signal portions an average part and a variance part are determined by the analysis circuit. A constant part of the digital signal is determined by compensating the average part with the variance part by the analysis circuit. For instance, a bias correction of amplitude is performed by using the average part and the variance part, namely for compensating the average part with the variance part.

The advantages achieved in view of the before mentioned test and/or measurement instrument are correspondingly achieved also in view of the method for determining a power of an input signal. In essence, the power contributions of noise portions included within the evaluated digital signal can be reliably identified and extracted when determining the true power of the wanted signal component under the assumption that the power of the wanted signal component is constant—at least during the time used for the evaluation procedure. Thus, the method enables the precision and accuracy of the power determining procedure to be enhanced as compared to prior art approaches.

In an embodiment, the input signal can be based on an external signal, for example acquired in view of a device under test (DUT). For detecting the input signal, a sensor circuit may be provided external to the test and/or measurement instrument. The sensor circuit may then be coupled to the input of the test and/or measurement instrument.

According to an aspect, the input signal, for example, may be a high-frequency signal such as a radio frequency (RF) signal comprising signal portions having a frequency of 100 kHz or more, 1 MHz or more, 100 GHz or more, etc.

In some embodiments, the digital signal comprising multiple samples provided by the ADC may also be considered to represent a data stream. Put differently, the data stream may comprise a digital signal having multiple samples. The analysis circuit is then configured to extract individual portions of the data stream corresponding to different samples of the digital signal and to insert the different samples into at least two partitions.

Since the ADC digitizes the input signal such that the digital signal comprises multiple samples, the multiple samples differ from each other with regard to the time at which the ADC generated the respective samples. Therefore, as the different samples are separated into different partitions, also the partitions are different from each other in view of time, e.g. a reference time value of each partition. Put differently, the partitions may be regarded as separate fractions of the digital signal to be evaluated which differ from each other with regard to time.

Generally, I/Q data may be acquired which relate to the samples that are separated into the different partitions.

In an example, the test and/or measurement instrument is a vector network analyzer, VNA, a spectrum analyzer, a signal analyzer or an oscilloscope. Of course, the test and/or measurement instrument may comprise additional parts or components for providing additional functionalities with regard to these exemplary device types.

In an embodiment, the at least one analysis circuit is configured to determine a noise part of the digital signal, e.g. by taking the variance part into account, for instance by compensating the variance part with the average part. As indicated above, the variance part, namely the variance of the power, is affected by the contributions of noise. Therefore, the contribution of signal portions to the overall power in excess of the signal power, namely the power of the wanted signal component, can be determined by considering the variance part, thereby obtaining the noise part or the noise signal component. Accordingly, the noise signal component included within the analyze digital signal can be determined, irrespective of whether the noise originates from noise of the input signal or noise caused by components of the test and/or measurement instrument.

In an embodiment, the at least one acquisition circuit comprises at least one filter circuit for filtering the input signal received, thereby setting a resolution bandwidth. Hence, the filter determines the resolution with regard to the frequency intervals considered during the evaluation of the input signal. The filter circuit may also cause noise signal contributions. However, based on the evaluation procedure carried out by the test and/or measurement instrument these noise signal contributions can also be compensated or determined.

In an embodiment, the filter circuit may be arranged upstream of the ADC. The filter circuit may be set to comply with the settings of the ADC, e.g. its sampling rate.

In an embodiment, the average part and the variance part may be determined for a frequency interval. A size of the frequency interval depends on settings of the acquisition circuit. The frequency interval may relate to the transformed signal portion. The size of the frequency interval is adjustable by setting the acquisition circuit, namely the sampling rate.

Generally, the transformed signal portion may comprise several frequency bins.

In an embodiment, the frequency interval is considered for all partitions generated by the analysis circuit. For example, the partitions may be evaluated with regard to each other in view of frequency intervals which correspond to each other. Hence, corresponding frequency values, e.g. the respective frequency components, are evaluated when determining the constant part and/or noise part of the digital signal.

In an embodiment, the at least one analysis circuit is configured to output the determined constant part and/or noise part via a display of the test and/or measurement instrument or an output of the test and/or measurement instrument. The output of the test and/or measurement instrument may be connected with another device, e.g. for further processing. Accordingly, the determined constant part and/or noise part can be provided for additional evaluation procedures or further processing. Moreover, a user of the test and/or measurement instrument may get an impression of the different parts through the display.

According to an aspect, the at least one analysis circuit, for example, is configured to determine an accuracy of the determined constant part and/or noise part and to output the accuracy of the determined constant part and/or noise part. The accuracy specifies how precise the constant part and/or the noise part are determined in view of a reference value, such as a value of power of the constant part being accurate according to X dB, where X indicates the determined accuracy value. For example, common accuracy determination techniques may be applied in this regard, such as statistical determination procedures.

In an embodiment, the at least one analysis circuit is configured to average the signal portion of each partition regarding I/Q components before the signal portions of each partition are transformed into the frequency domain. For example, the averaging of the I/Q components is advantageous if the underlying input signal comprises an amplitude-modulated and phase-modulated signal profile, for example a periodic profile. In this case, the analysis circuit is able to average the respective individual I/Q components thereof, namely the in phase (I) and quadrature (Q), which describe the cross relation for amplitude-modulated and phase-modulated digital signals. Due to the averaging applied by the analysis circuit, the modulation can be neglected and a timely constant value for the I/Q components is achieved.

In an embodiment, the at least one analysis circuit may be configured to continuously separate additional samples of the digital signal received into additional partitions. Hence, the analysis circuit generates new or additional partitions if it receives additional samples of the digital signal. Therefore, an ongoing evaluation procedure is achieved which allows to continuously evaluate the constant part and/or the noise part. For instance, this may be used to enhance the accuracy determined in view of the constant part and/or the noise part as new transformed signal portions are obtained and, thus, new specific frequency components are gathered which may be used for determining the average part and the variance part. The analysis circuit is configured to apply same analysis procedures to the additional partitions as compared to the at least two partitions.

In an embodiment, the at least one analysis circuit is configured to continuously separate additional samples of the digital signal acquired into additional partitions until an accuracy level of the determined constant part and/or noise part is increased above an accuracy threshold value. As to the increased number of partitions, the accuracy can be determined more precisely since the statistical database underlying the determination procedure is enlarged. Also, based on the enlargement of the database, usually the accuracy can be adapted, e.g. improved. Therefore, desired accuracy values can be achieved such that the reliability of the determined constant part and/or noise part meets desired standards. As indicated above, the number of frequency components is increased based on which the average part and the variance part are determined.

As already mentioned, multiple samples of the digital signal can be included within a single partition. As to the sampling frequency of the ADC, each sample of the digital signal corresponds to a specific time. Therefore, the partition length on the one hand depends on the number of samples per partition.

In an embodiment, the at least one analysis circuit is configured to set a partition length of each partition. Here, the partition length corresponds to a sum of samples included within the respective partition. The analysis circuit may adjust the partition length based on the number of samples per partition.

In an embodiment, the at least two partitions may have a same partition length. Accordingly, the partitions each comprise the same number of samples. This simplifies the evaluation and determination of the average part, the variance part, the constant part and/or the noise part. This ensures that the average part and the variance part can be determined for each specific frequency component, e.g. frequency bin, of the respective transformed signal portions, as all transformed signal portions have the same number of frequency components, e.g. frequency bins.

In an embodiment, the test and/or measurement instrument comprises at least one user interface configured to receive a user input. Therefore, the user may input certain specifications to influence the evaluation procedure performed by the test and/or measurement instrument. As indicated above, the at least one analysis circuit is generally configured to set the partition length of each partition, which however may be done based on a user input.

In an embodiment, the user interface may be provided on the test and/or measurement instrument. Accordingly, the user needs to have access to the test and/or measurement instrument for providing the input(s) to set the test and/or measurement instrument.

Alternatively or additionally, the user interface may be provided by a web access such as a communication with a web server or an interface which is configured for known protocols, such as Standard Commands for Programmable Instruments. Therefore, a remote control is established.

According to an embodiment, a partition length of each partition is determined by a number of samples included in each of the partitions. In an embodiment, the partition length is specifiable by a user input or determinable by the at least one analysis circuit based on settings of the acquisition circuit. As indicated above, the settings may be set by the user via the user interface. For instance, predefined settings may be adapted by the user accordingly. In this regard, the analysis circuit may read out the settings of the acquisition circuit, such as the sampling frequency of the ADC and/or the resolution bandwidth of the filter circuit. Taking into account the numbers of samples separated into each partition, the partition length can be determined by the analysis circuit. In an alternative, the partition length may be specified according to the desires of a user of the test and/or measurement instrument and the analysis circuit may set the parameters accordingly such that the desired partition length is met.

In an embodiment, the at least one analysis circuit is configured to set a minimum number of partitions. The minimum number of partitions is specifiable by a user input or determinable by the at least one analysis circuit based on a user input specifying an accuracy requirement to be considered for the determination of the constant part and/or noise part. The number of partitions represents a parameter by which the statistical database can be enlarged. Accordingly, the accuracy can be adjusted based on the number of partitions. Hence, based on the accuracy requirement specified by the user, the analysis circuit can determine how many partitions are required to fulfill the accuracy requirement. Then, the respective partitions can be generated and used during the evaluation procedure by the analysis circuit.

According to an embodiment, the transformation procedure applied by the analysis circuit for transforming the samples of the digital signal into the frequency domain may relate to a fast Fourier transformation (FFT), or a discrete Fourier transformation (DFT).

In an embodiment, the acquisition circuit comprises additional components, such as an attenuator circuit, a mixing circuit, an amplifier circuit, or a downconverter circuit. While the circuits may be applied upstream of the ADC, the downconverter circuit may also be implemented downstream of the ADC. Based on these exemplary additional components, the test and/or measurement instrument may provide additional functionalities. Generally, all of these circuits may introduce a noise contribution that however can be determined and compensated for as indicated above.

Generally, the method may be used at zero span mode of the test and/or measurement instrument, namely in a mode in which a local oscillator does not sweep. Alternatively, the method may be used for several frequencies at the same time.

According to another aspect, the present disclosure also relates to a data processing device comprising means for carrying out any of the methods described herein. In an embodiment, these means may include, for example, one or more processor circuits configured (e.g., programmed) for carrying out any of methods disclosed herein. The advantages achieved in view of the before mentioned method for determining a power of an input signal are correspondingly achieved also in view of the data processing device.

According to another aspect, the present disclosure also relates to a computer program product comprising instructions which, when executed by a processor circuit, cause the processor circuit to carry out any of the method as described herein. The advantages achieved in view of the before mentioned method for determining a power of an input signal are correspondingly achieved also in view of the computer program product.

According to another aspect, the present disclosure also relates to a computer-readable storage medium comprising instructions which, when executed by a processor circuit, cause the processor circuit to carry out any of the methods described herein. The advantages achieved in view of the before mentioned method for determining a power of an input signal are correspondingly achieved also in view of the computer-readable storage medium.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically illustrates an example of a test and/or measurement instrument according to an embodiment;

FIG. 2 schematically illustrates an example of a method according to an embodiment, and,

FIG. 3 schematically illustrates an example of a frequency spectrum for the instrument and the method.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

All of the features disclosed hereinafter with respect to the example embodiments and/or the accompanying FIGURES can alone or in any sub-combination be combined with features of the aspects of the present disclosure including features of preferred embodiments thereof, provided the resulting feature combination is reasonable to a person skilled in the art.

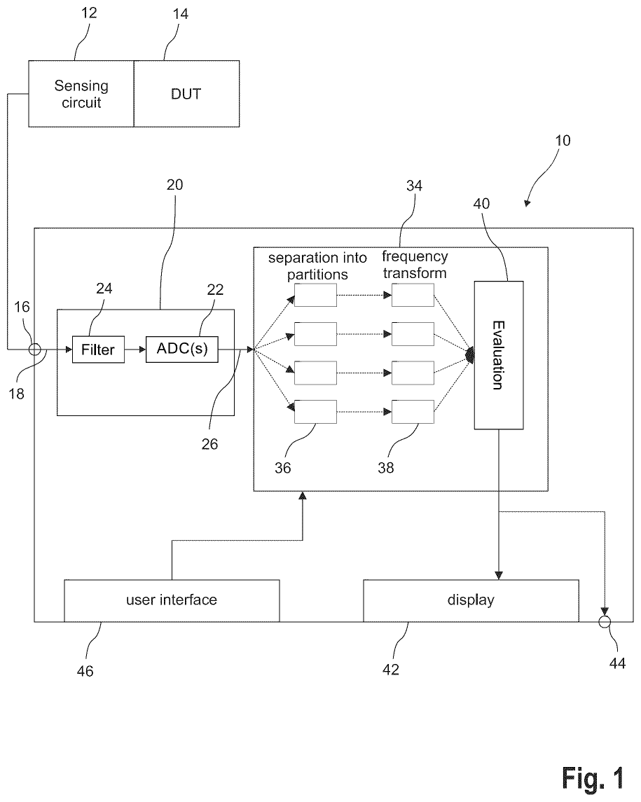

FIG. 1 schematically illustrates an example of a test and/or measurement instrument according to an embodiment of the disclosure. According to the present embodiment, the test and/or measurement instrument 10 is coupled to an external sensing circuit 12, for instance a probe, which is configured to detect an analog signal, in particular an analog RF signal, in view of a DUT 14. Based on the detected analog signal, the DUT 14 is supposed to be evaluated and characterized.

As shown in the embodiment of FIG. 1, the test and/or measurement instrument 10 comprises an input 16 which receives the detected analog signal as an input signal 18. Alternatively, the input signal 18 may be also directly inputted to the input 16 of the test and/or measurement instrument 10 for evaluation purposes, e.g. without being measured/probed.

Subsequent to the input 16, the test and/or measurement instrument 10 comprises an acquisition circuit 20. The acquisition circuit 20 comprises at least an ADC 22. According to the embodiment shown, the acquisition circuit 20 also comprises a further circuit 24, for instance a filter circuit, being arranged upstream of the ADC 22. The filter circuit is configured for filtering the input signal 18. Thereby, a resolution bandwidth is set through the processing performed by the filter circuit.

Generally, the further circuit 24 may relate to other circuits than the filter circuit, e.g. an attenuator circuit, a mixing circuit, an amplifier circuit, or a downconverter circuit. The respective further circuit 24 may also be arranged downstream of the ADC 22.

The ADC 22 is configured to digitize the input signal 18, which is optionally filtered by the filter circuit or processed by the filter circuit 24, for providing a digital signal 26 which comprises multiple samples. The number of samples contained within the digital signal 26 per time unit depends on the sampling frequency of the ADC 22.

Notably, the digital signal 26 having multiple samples comprises wanted signal components which can be reliably used to characterize the DUT 14. However, the digital signal 26 having multiple samples also comprises noise components which are caused by various reasons, such as by external noise having an influence on the signal detection performed by the sensing circuit 12, on the analog signal acquired itself, or by the processing performed by the components of the acquisition circuit 20 of the test and/or measurement instrument 10.

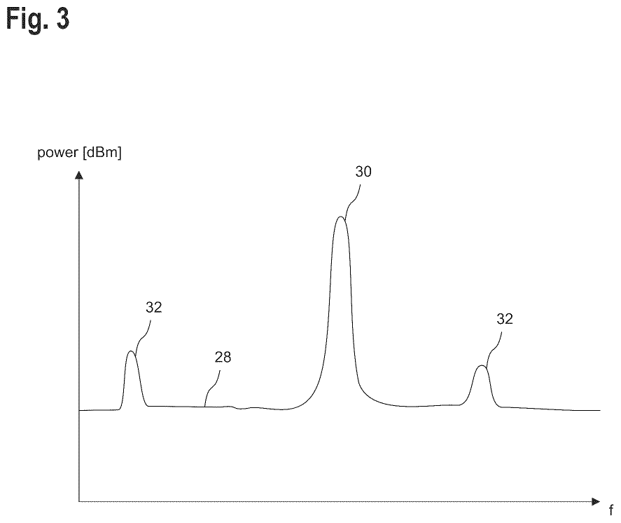

In this regard, FIG. 3 schematically illustrates an example of a frequency spectrum 28 for the test and/or measurement instrument 10 and the method explained below. On the Y-axis, the power of the digital signal is shown versus the frequency depicted on the X-axis. The signal profile shows that the example frequency spectrum 28 comprises a wanted signal component 30 and noise signal components 32.

Prior art approaches, such as RMS detectors, used for determining the power of a signal, assign the contributions of the noise signal components 32 to the wanted signal component 30 as to the limited resolution bandwidth. Put differently, prior art solutions cannot distinguish between contributions originating from the wanted signal components 30 and noise signal components 32. Therefore, the determination of the true signal power of those signal portions underlying the signal in question, is influenced due to the noise signal components 32 such that the determination of the power leads to false results. This deficiency can be compensated by the test and/or measurement instrument 10.

In an embodiment, the digital signal 26 having multiple samples is provided to the analysis circuit 34 of the test and/or measurement instrument 10. The analysis circuit 34 is configured separate different samples of the digital signal 26 into at least two partitions 36. Of course, multiple samples of the digital signal 26 may also be included within a single partition 36. However, at least two different partitions 36 are made use of by the analysis circuit 34.

Depending on the number of samples of the digital signal 26 included in each partition 36, the partition length of the partitions 36 may vary. Put differently, the analysis circuit 34 is configured to set a partition length of the partitions 36. In this regard, the partition length of the partitions 36 depends on the number of samples of the digital signal 26 included in the respective partitions 36.

However, the partition length of the partitions 36 may also depend on one or more settings of the acquisition circuit 20, for instance a resolution bandwidth together with a sampling rate of the ADC 22. Typically, the partition length of the individual partitions 36 is similar for the partitions 36.

Subsequently, the analysis circuit 34 transforms the signal portions of the at least two partitions 36, namely the samples of the respective partitions 36, into the frequency domain such that transformed signal portions 38 are achieved. In this regard, an FFT or DFT may be applied by the analysis circuit 34.

The analysis circuit 34 then applies an evaluation procedure on the transformed signal portions 38, here depicted as an evaluation 40, where for the different transformed signal portions 38 an average part and a variance part are determined by the analysis circuit 34.

In an embodiment, the variance part relates to a power contribution of noise. Since the average part also inherently includes the contribution of the noise signal component, this allows that the analysis circuit 34 is configured to determine a constant part of the digital signal 26 having a constant signal power by compensating the average part with the variance part. Hence, the noise signal component can be compensated within the average part such that the wanted signal component of the digital signal 26 can be determined.

In other words, the analysis circuit 34 is configured to determine the constant part with constant power, which relates to the wanted signal, and a noise part included within the digital signal 26 based on the determined average part and the variance part.

For the determination of the average part and the variance part, the analysis circuit 34 applies a frequency interval, which is considered in view of all partitions 36 included within the evaluation procedure, e.g. a specific frequency component, namely a frequency bin like a FFT bin. Put differently, the analysis circuit 34 analyzes the transformed signal portions of the various partitions 36 with regard to corresponding frequency intervals.

In other words, a specific frequency component, e.g. a specific frequency bin, of the different transformed signal portions may be taken into account when determining the average part and the variance part. The specific frequency component, e.g. the specific frequency bin, may relate to the respective first frequency component of the different transformed signal portions or the respective second frequency component of the different transformed signal portions and so on.

According to an example, the average part and the variance part may be determined for each frequency component, e.g. each frequency bin, across all transformed signal portions. Assuming the transformed signal portions comprise six frequency components, the average part and the variance part may be calculated for each of the six frequency components accordingly.

As to the sampling procedure of the ADC 22, the digital signal 26 having multiple samples should in principle comprise same signal characteristics. However, in reality the samples of the digital signal 26 are different from each other as to the noise signal components included therein. Therefore, when applying corresponding frequency intervals for analyzing the transformed signal portions of the different partitions 36, the power varying characteristics can be determined by the analysis circuit 34.

In an embodiment, the size of the frequency interval depends on settings of the acquisition circuit 20. For example, the resolution bandwidth which is set by the filter circuit 24 determines the size of the frequency intervals.

According to the embodiment of FIG. 1, the test and/or measurement instrument 10 also comprises a display 42 and an output 44 via which a different device can be connected with the test and/or measurement instrument 10. In an embodiment, the determined constant part and/or noise part can be outputted by the display 42 or the output 44 by the analysis circuit 34 for further use.

In an embodiment, the analysis circuit 34 is also configured to determine an accuracy of the determined constant part and/or noise part. The accuracy describes which error interval has to be considered for the respectively determined constant part and/or noise part with regard to the actual value of the constant part and/or noise part. The determined accuracy of the constant part and/or noise part can also be outputted by the analysis circuit 34 through the display 42 and/or the output 44.

In an embodiment, the analysis circuit 34 is also configured to continuously separate additional samples of the digital signal 26 into additional partitions 36. Subsequently, these additional partitions 36 are considered within the evaluation procedure applied by the analysis circuit 34. As to the increased number of partitions 36, the statistical database during the evaluation 40 is increased, such that the accuracy of the determined constant part and/or noise part can be improved, i.e. reduced to lower levels.

In a certain embodiment, when the digital signal 26 comprises in amplitude-modulated and phase-modulated signal profile, the analysis circuit 34 is also configured to average each partition 36 regarding the underlying IQ components before the signal portions of the partitions 36 are transformed into the frequency domain. Hence, the effects caused by the modulation can be compensated.

In an embodiment, the analysis circuit 34 may also consider an accuracy threshold value which is to be achieved during the evaluation 40. For example, the accuracy threshold value may be set through a user input using a user interface 46 of the test and/or measurement instrument 10. The analysis circuit 34 then continuously separates samples of the digital signal 26 into additional partitions 36 until the determination of the constant part and/or noise part can be performed at an accuracy such that the accuracy threshold value is met.

In an embodiment, the user interface 46 may also be used by the user such that the analysis circuit 34 receives a user input which specifies the partition length of the partitions 36. In an alternative, the user interface 46 may also be used by user to specify settings of the acquisition circuit 20 which indirectly influence the partition length of the partitions 36. For example, a user may choose a specific sampling rate of the ADC 22.

According to another embodiment, a user may use the user interface 46 for specifying an accuracy threshold value which is to be met by the evaluation 40 performed by the analysis circuit 34. With the user-specified accuracy threshold value, the analysis circuit 34 is configured to generate sufficient partitions 36 and to separate sufficient samples of the digital signal 26 into an appropriate number of partitions 36 such that the constant part and/or noise part of the digital signal 26 can be determined with an accuracy being higher than the user-specified accuracy threshold value.

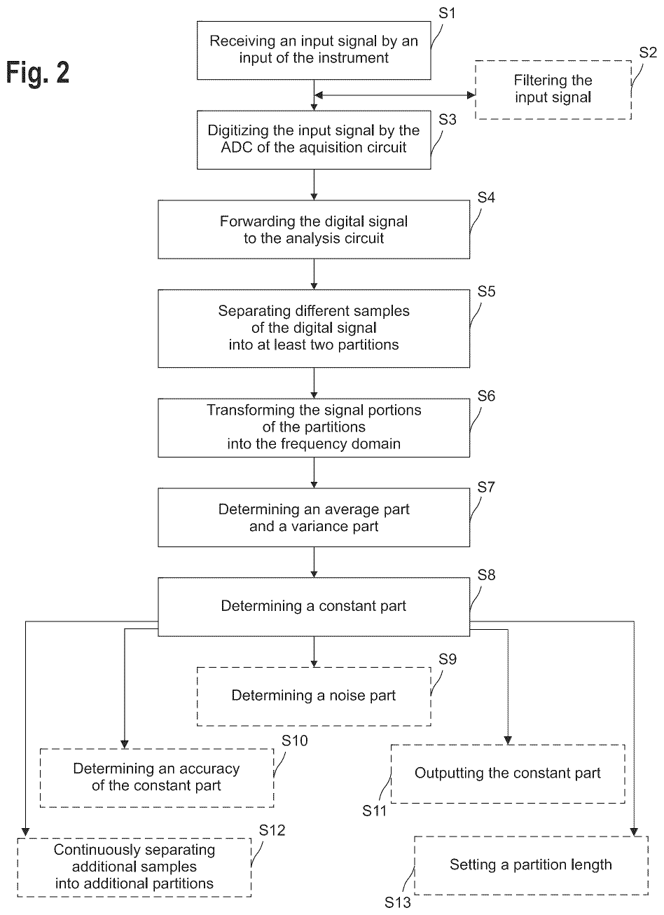

FIG. 2 schematically illustrates an example method according to an embodiment, which can be performed by the test and/or measurement instrument 10 described above. Optional steps are shown in dashed lines.

According to step S1, the input signal 18 is received by the input 16 of the test and/or measurement instrument 10. For example, the input signal 18 may relate to an analog signal which is acquired by an external sensing circuit 12 in view of an external DUT 14.

In optional step S2, the input signal 18 is filtered using the filter circuit, being the further circuit 24 in the shown embodiment of FIG. 1, of the at least one acquisition circuit 20 of the test and/or measurement instrument 10. By the filtering mechanism, the filter circuit sets a resolution bandwidth, RBW, which determines the frequency resolution achievable by the later performed evaluation procedures.

In step S3, the input signal 18 is digitized by the ADC 22 of the acquisition circuit 20 of the test and/or measurement instrument 10. Thereby, the digital signal 26 comprising the multiple samples is generated. Accordingly, the ADC 22 is arranged downstream of the filter circuit. The digital signal 26 comprises the wanted signal component 30 and the noise signal component 32, as was explained in view of the frequency spectrum 28 depicted in FIG. 3.

According to step S4, the digital signal 26 is forwarded to the at least one analysis circuit 34 of the test and/or measurement instrument 10. Hence, the analysis circuit 34 and the acquisition circuit 20 are coupled with each other.

In subsequent step S5, different samples of the digital signal 26 are separated into the at least two partitions 36 by the analysis circuit 34. This separation is crucial for allowing the signal portions included in the different partitions 36 to be evaluated with regard to each other. Put differently, the signal portions included in the different partitions 36 are put in relation to each other for identifying signal portions having varying signal powers.

Next, in step S6 the analysis circuit 34 transforms the signal portions of the at least two partitions 36 into the frequency domain. For example, a FFT or a DFT procedure may be applied in this regard. Thereby, the transformed signal portions 38 are obtained.

According to subsequent step S7, the analysis circuit 34 determines for the different transformed signal portions 38 the average part and the variance part. As indicated above, this may be done based on a specific frequency component, namely frequency bin, in the respective transformed signal portions 38. In an embodiment, the average part and the variance part may be calculated for all frequency components/bins encompassed in the respective transformed signal portions 38.

Subsequently, in step S8 the analysis circuit 34 determines the constant part of the digital signal 26 having the constant power by compensating the average part with the variance part, for example the respective average parts with the corresponding variance parts for the several frequency components/bins.

Therefore, the signal portions can be identified within the digital signal 26 which do not relate to noise. In other words, the constant part determined by the analysis circuit 34 is assigned to the power of the wanted signal component 30 of the analyzed digital signal 26. Accordingly, the wanted signal component 30 comprises a constant power for the time period of the evaluation procedure applied by the test and/or measurement instrument 10. The determination of the constant part of the digital signal 26 relies on the comparison of the transformed signal portions 38 included in different partitions 36 since this comparison allows signal portions having varying signal powers to be identified.

Optionally, the method may also comprise the step S9, according to which the analysis circuit 34 determines the noise part of the digital signal 26 by taking the variance part(s) into account, e.g. by compensating the variance part(s) with the average part(s).

In an embodiment, the analysis circuit 34 may also determine the accuracy of the constant part and/or the noise part according to optional step S10.

As was explained already before, the so determined constant part and/or noise part can be outputted by the analysis circuit 34 according to optional step S11. For example, the constant part and/or the noise part can be outputted by the analysis circuit 34 through the display 42 or the output 44. Of course, the accuracy determined in step S10 can also be outputted by the analysis circuit 34 through the display 42 or the output 44 in step S11.

The method may also comprise the optional step S12, according to which the analysis circuit 34 may continuously separate any additional samples of the digital signal 26 received from the acquisition circuit 20 into additional partitions 36. Therefore, the database for the comparison applied during the evaluation 40 of the analysis circuit 34 may be enlarged, such that for example the accuracy may be narrowed down due to statistical reasons.

According to this embodiment, the method may also comprise the optional step S13, in which the analysis circuit 34 may set the partition length of the partitions 36. In this regard, the analysis circuit 34 may determine the number of samples to be included in each partition 36 which directly influences the partition length. In addition, the analysis circuit 34 may read out the parameters of the acquisition circuit 20.

In an embodiment, the method may also comprise additional optional steps, such as receiving a user input through the user interface 46. In this regard, the user input received at the user interface 46 may specify an accuracy threshold value which is to be met during the evaluation 40 carried out by the analysis circuit 34 or may specify certain parameters of the test and/or measurement instrument 10, such as the sampling rate of the ADC 22 or directly the partition length of the partitions 36 generated by the analysis circuit 34.

Therefore, a user may influence the method carried out by the test and/or measurement instrument 10 in various ways. The analysis circuit 34 may take the user inputs received by the user interface 46 into account and adjust the method accordingly. For example, if a user specifies a certain accuracy threshold value to be met, the analysis circuit 34 may separate additional samples of the digital signal 26 into additional partitions 36 until the accuracy meets the accuracy threshold value as specified by the user.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components, such as the test and/or measurement instrument 10, the sensing circuit 12, the DUT 14, etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuity to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuity disclosed herein, etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A test and/or measurement instrument for determining a power of an input signal, the test and/or measurement instrument comprising:
at least one input for receiving an input signal,
at least one acquisition circuit being connected to the input, the at least one acquisition circuit comprising at least one analog-to-digital converter, wherein the at least one analog-to-digital converter is configured to digitize the input signal received from the at least one input, thereby providing a digital signal comprising multiple samples, wherein the digital signal comprises a wanted signal component and a noise signal component, and
at least one analysis circuit being connected with the at least one acquisition circuit such that the at least one analysis circuit receives the digital signal from the at least one acquisition circuit, wherein the at least one analysis circuit is configured to:
separate different samples of the digital signal into at least two partitions,
transform signal portions of the at least two partitions into a frequency domain, thereby obtaining transformed signal portions,
determine for the different transformed signal portions an average part and a variance part, and
determine a constant part of the digital signal having a constant power by compensating the average part with the variance part.

2. The test and/or measurement instrument of claim 1, wherein the at least one analysis circuit is configured to determine a noise part of the digital signal.

3. The test and/or measurement instrument of claim 1, wherein the at least one acquisition circuit comprises at least one filter circuit for filtering the input signal received, thereby setting a resolution bandwidth.

4. The test and/or measurement instrument of claim 1, wherein the average part and the variance part are determined for a frequency interval, and wherein a size of the frequency interval depends on settings of the acquisition circuit.

5. The test and/or measurement instrument of claim 1, wherein the at least one analysis circuit is configured to output the determined constant part via a display of the test and/or measurement instrument or an output of the test and/or measurement instrument.

6. The test and/or measurement instrument of claim 5, wherein the at least one analysis circuit is configured to determine an accuracy of the determined constant part and to output the accuracy of the determined constant part.

7. The test and/or measurement instrument of claim 1, wherein the at least one analysis circuit is configured to average the signal portion of each partition regarding I/Q components before the signal portions of each partition are transformed into the frequency domain.

8. The test and/or measurement instrument of claim 1, wherein the at least one analysis circuit is configured to continuously separate additional samples of the digital signal acquired into additional partitions, and wherein the analysis circuit is configured to apply same analysis procedures to the additional partitions as compared to the at least two partitions.

9. The test and/or measurement instrument of claim 8, wherein the at least one analysis circuit is configured to continuously separate additional samples of the digital signal acquired into additional partitions until an accuracy level of the determined constant part is increased above an accuracy threshold value.

10. The test and/or measurement instrument of claim 1, wherein the at least one analysis circuit is configured to set a partition length of each partition.

11. The test and/or measurement instrument of claim 1, wherein the at least two partitions have a same partition length.

12. The test and/or measurement instrument of claim 1, wherein the test and/or measurement instrument comprises at least one user interface configured to receive a user input.

13. The test and/or measurement instrument of claim 1, wherein a partition length of each partition is determined by a number of samples included in each of the partitions, and wherein the partition length is specifiable by a user input or determinable by the at least one analysis circuit based on settings of the acquisition circuit.

14. The test and/or measurement instrument of claim 1, wherein the at least one analysis circuit is configured to set a minimum number of partitions, wherein the minimum number of partitions is specifiable by a user input or determinable by the at least one analysis circuit based on a user input specifying an accuracy requirement to be considered for the determined constant part.

15. A method for determining a power of an input signal, the method comprising:
receiving an input signal by at least one input of a test and/or measurement instrument,
digitizing the input signal by at least one analog-to-digital converter of at least one acquisition circuit of the test and/or measurement instrument, thereby generating a digital signal comprising multiple samples, wherein the digital signal comprises a wanted signal component and a noise signal component,
forwarding the digital signal to at least one analysis circuit of the test and/or measurement instrument,
separating different samples of the digital signal into at least two partitions by the at least one analysis circuit,
transforming signal portions of the at least two partitions into frequency domain by the at least one analysis circuit, thereby obtaining transformed signal portions,
determining for the different transformed signal portions an average part and a variance part by the at least one analysis circuit, and
determining a constant part of the digital signal having a constant power by compensating the average part with the variance part by the at least one analysis circuit.

16. The method of claim 15, wherein the at least one analysis circuit determines a noise part of the digital signal.

17. The method of claim 15, wherein the determined constant part is output via at least one display of the test and/or measurement instrument or an output of the test and/or measurement instrument.

18. The method of claim 15, wherein an accuracy of the determined constant part is determined by the at least one analysis circuit.

19. The method of claim 15, wherein additional samples of the digital signal received are continuously separated into additional partitions by the at least one analysis circuit or wherein additional samples of the digital signal received are continuously separated into additional partitions by the at least one analysis circuit until an accuracy level of the determined constant part is increased above an accuracy threshold value.

20. The method of claim 15, wherein the at least one analysis circuit sets a partition length of the at least two partitions based on a specification of the partition length by a user input or based on settings of the acquisition circuit.
